(19) United States
(12) Patent Application Publication
(10) Pub. No.: US 2011/0160885 A1
(43) Pub. Date: Jun. 30, 2011

(54) DIGITAL MUSIC DISTRIBUTION COMPONENT

(76) Inventor: Boris Itskov, Concord (CA)

(21) Appl. No.: 12/998,014

(22) PCT Filed: Sep. 9, 2009
(86) PCT No.: PCT/CA2009/001230

§ 371 Date: Mar. 9, 2011

(30) Foreign Application Priority Data
Sep. 9, 2008 (CA) 2639460

(51) Int. Cl. G06F 17/00

(52) U.S. Cl. 700/94

(57) ABSTRACT

A media center component for receiving digital records (music/video) includes a web based communication function and includes a plurality of outputs for connecting to different audio outputs. These different outputs include an output for connection to a separate stand alone audio system or for connection to an output for speakers directly. The media center component includes its own controls for modifying the outputted signal controls. The media center component also includes an input for receiving digital records to be played.

### FIELD OF THE INVENTION

The present invention relates to musical distribution components and in particular to a media center component that is in communication with a remote digital music server where musical records are provided to the media center component for effective play in a public establishment.

### BACKGROUND OF THE INVENTION

There are a number of digital jukebox systems where a digital jukebox is provided in a commercial establishment, and this digital jukebox allows a patron to effect payment and provide an indication of the particular musical record to be played, whereafter this communication is provided to a remote digital library and the selected record is downloaded and/or streamed to the digital jukebox for play. Typically, the digital jukebox is the end play device, and the musical record is played on the jukebox.

JVL of Concord, Ontario have proposed a number of digital music systems where the functions of the digital jukebox have been divided, such that a game terminal that is provided on the network can act as an input device for the selection of digital music to be played in a commercial establishment. Preferably, a separate receiving component (media center component) is provided on the network in the commercial establishment, and allows for the digital record to be played.

The present invention discloses improvements with respect to the digital music receiving component that is typically provided in such a commercial establishment.

### SUMMARY OF THE INVENTION

A media center component for receiving digital records (music/video) includes a network communication function and includes a plurality of outputs for connecting to different audio outputs. These different outputs include an output for connection to a separate stand alone audio system or for connection to an output for speakers directly. The media center component includes its own controls for modifying the outputted signal controls. The media center component also includes an input for receiving digital records to be played and preferably includes a further input for receiving an analog signal to be played.

### BRIEF DESCRIPTION OF THE DRAWINGS

Preferred embodiments of the invention are shown in the drawings, wherein:

FIG. 1 is a schematic overview of a networked game system that also allows for the ordering and play of music recordings in a commercial establishment;

FIG. 2 shows a schematic overview of portions of the system provided in the commercial establishment for playing of musical recordings;

FIG. 3 shows a front view of the media center component and various functions thereof;

FIG. 4 is a rear view of the media center component showing various input and output ports;

FIG. 5 is a screen shot of the initial screen presented on the media center component when it is activated;

FIG. 6 is a screen shot of the media center component allowing volume level on the different output channels to be adjusted;

FIG. 7 is a screen shot showing an initial time and date entry;

FIG. 8 is a screen shot showing a time and date entry based on auto or manual input;

FIG. 9 is a screen shot showing the manual input;

FIG. 10 is a screen shot showing the selection of different network connections;

FIG. 11 is a screen shot of a confirmation to save settings;

FIG. 12 is a screen shot of the wireless networks detected;

FIG. 13 is a screen shot to define a new name of a network;

FIG. 14 shows the ability to name the particular network;

FIG. 15 is a screen shot showing an authentication selection that can be made with respect to a WIFI connection;

FIG. 16 is a screen shot showing the input of an authentication key;

FIG. 17 is a screen shot showing volume levels, both minimum and maximum, of particular channels;

FIG. 18 is a similar screen shot to FIG. 17;

FIG. 19 is a screen shot showing adjustment of the minimum volume;

FIG. 20 is a screen shot of the volume level and a particular digital record being played on channel 1;

FIG. 21 is a screen shot of the media center component when the particular song “RANDY TRAVIS” and a particular title is playing;

FIGS. 22 and 23 illustrate the screen shot where 1 channel is selected in FIG. 22, and by pressing or actuating the “ALL” configuration in 22, then the volume of all channels indicated by solid channels 1, 2, 3 can be adjusted as shown in FIG. 23;

FIG. 24 shows adjustment of the separate channel 22;

FIG. 25 is a screen shot of the media center component when muting has been selected with respect to channel 2;

FIG. 26 is a screen shot of the volume level on all three channels when the “ALL” button has been pressed and “MUTING” button released;

FIG. 27 is a screen shot showing an equalizer adjustment that can be accomplished;

FIG. 28 shows and adjustment of that;

FIG. 29 shows adjustment of the media center component for different filtering options;

FIG. 30 is an operator screen showing access to more sophisticated modes including an “ACCESS” mode that is indicated in FIG. 31;

FIGS. 32 and 33 show changing of access codes;

FIGS. 34 through 36 show other adjustments that can be made to the media center component.

### DETAILED DESCRIPTION OF THE PREFERRED EMBODIMENTS

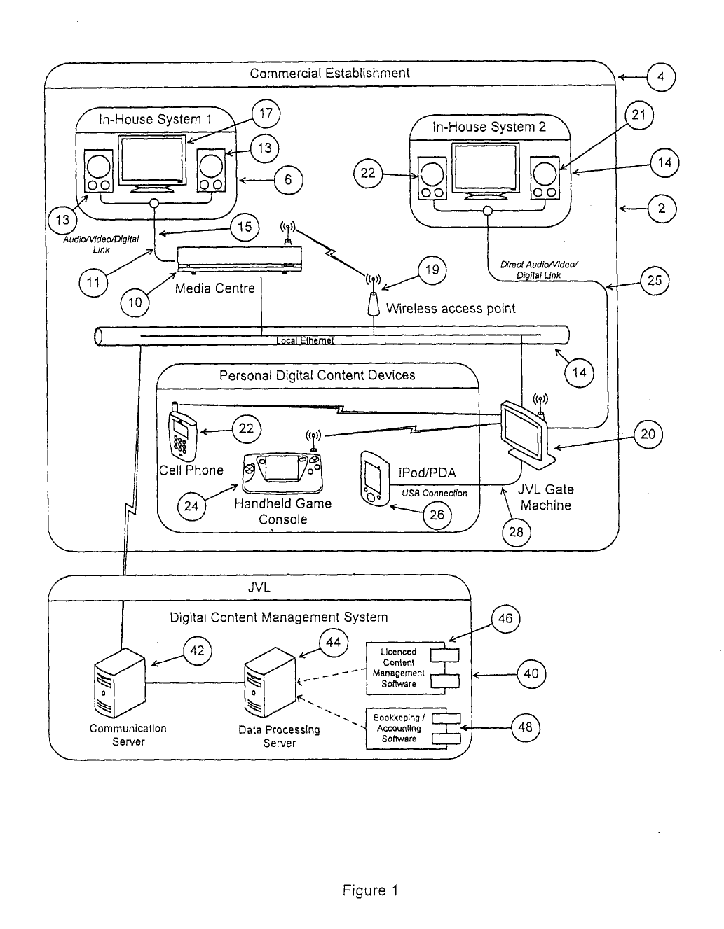

The media play system 2 shown in FIG. 1 is for use in a commercial or public establishment generally indicated as 4. Such commercial establishments include restaurants, night clubs and other public entertainment facilities or businesses. The performance or play of digital content, subject to copyright protection, (audio video, game contents, etc.) in public establishments requires appropriate authorization.

Shown within the commercial establishment is a first in-house system 6 and a second in-house system 8. The in-house systems 6 and 8, each typically include an amplifier for receiving a signal from one or more source devices such as a CD player, hard drive, receiver etc. The signal is appropriately processed and provided to the speakers 13. This type of device can also control the video source signal. The Media Center 10 provides a communication and control switch function for integrating control gate 20 into existing systems.

Preferably, the various sources of multi-media content are connected to the Media Center 10 and the Media Center 10 provides the appropriate signal to one or more of the in-house systems 6 and 8. The control gate 20 can interrupt signals from other sources to the amplifier and essentially override other sources as may be required. In this way, the control gate and Media Center 10 provide a switch function for controlling the content on the in-house systems.

Advantageously, the control gate and Media Center 10 cooperate with existing audio/video systems.

The first in-house system 6 includes an audio link 11 connecting a pair of speakers 13 to the Media Center 10. A video link 15 connects the Media Center 10 to a display screen 17. The Media Center 10 includes a connection 12 to the local Ethernet network 14 and is typically in communication with the digital content management system 40 over the INTERNET. The digital content management system can store and provide audio and video content to the in-house system 6 in a somewhat conventional manner as the content and licensing provisions have been established, allowing the digital content management system to provide or authorize the specific use of the digital content. Preferably, the digital content management system is remotely located but this system could be located on site. The local Ethernet network can include a wireless transmission and receive capability 19 for communication with other related components.

The second in-house system 8 includes a pair of speakers 21, a display screen 23 and signal processing arrangement, and a direct digital link 25 connecting these components to the control gate 20. This embodiment also includes the control of signals to the in-house system 8. This arrangement may be appropriate for less sophisticated applications or systems as a separate Media Center 10 is not used.

The control gate 20 allows effective communication with any of a series of personal digital content devices such as the cell phone 22, the handheld game console 24, and/or the IPod/PDA 26. These personal digital content devices are owned by a customer and are capable of communicating in a wireless communication with the control gate 20. In addition, there can be a hard wire connection such as a USB connection 28 connecting a video player and/or IPod/PDA 26 with the control gate 20. Any of the personal digital content devices can include a suitable arrangement for effective communication with the control gate 20 including (as examples) a digital connection such as WiFi, infrared, GPRS, 3G, Bluetooth, HDMI and Optical Link, or by an analog link. These personal digital content devices are controlled by the user and digital files contained therein or identification information of the particular files can be effectively communicated to the control gate 20 for eventual play on the in-house system 8. The actual digital content can be provided from different sources in communication with the control gate.

The control gate 20 provides a coordinating function used to identify the content about to be played on the in-house system 8. This content or summary identification information can be communicated to the communication server 42 over the local Ethernet network 14 and reviewed by the digital processing server 44. In this way, the content about to be played on the in-house system 8 can be audited to provide the appropriate tracking of digital media content played in the commercial establishment. For example, if the audio content includes a series of songs, these songs can be identified and appropriately authorized for play on the in-house system 8. This authorization can also be used with respect to video content. The actual files or media content played may be provided by a local or remote database.

In some cases, the material being forwarded by one of the personal digital content devices will not be subject to copyright provisions, as the owner is unknown, or perhaps the user is already the owner. Therefore there may be some material that can be used with the in-house system 8 without authorization from the digital content Management System. For example, a certain office group may plan a marketing or sales meeting and wish to display this audio/video content for review in a more informal session. As the copyright owner is effectively the owner of the personal digital content, no further compensation would be required.

In contrast, particularly for audio content, the material may be music and this music or summary identification information may be reviewed to determine whether authorization is required. As technology advances, the music content can be analyzed to compare it to a host of known digital content for appropriate identification and any required authorization.

The control gate 20 includes the direct audio/video/digital link 25 to the in-house system 8. With this system, the customer who owns one of the personal digital content devices 22, 24, and 26, for example, has loaded these devices with music, video games, digital pictures, multimedia files, etc. that they wish to play on the in-house system 8. A suitable connection is made with the control gate 20 that typically includes a touch screen and software for effective communication with these devices. The information is then provided to the in-house system 8. The digital content management system 40 reviews digital content or ID information communicated thereto by the control gate and the data processing server 44 reviews and tracks the digital content for reporting to the appropriate Content Providers.

With this system, users of portable devices can have the content stored internally or can have access to an external source, for example, a satellite radio receiver or a source of streaming audio and/or video content. The important aspect is that the customer is in control of identifying the digital content. The control gate 20 is connected to the in-house multimedia system at the commercial establishment and transmits the user's selection to the system. The control gate 20 is connected to a digital control management system that verifies the content and tracks copyright payment information. This digital control management system process is typically carried out remotely of the commercial establishment. The control gate allows play of the selection through the above mentioned audio or video connection. The control gate 20 is preferably part of other systems that include a payment facility such as a video game terminal and/or a digital jukebox. As can be appreciated, this particular ability to allow the user to provide or identify the audio or video content, can advantageously supplement existing digital or video systems.

The control gate 20 provides the ability to select audio/video files to be played and/or the personal digital content device allows the user to select the files. The system is capable functioning in both of these manners. As the capability of personal digital content devices continues to expand, their use as an input device to select files will also expand.

With this arrangement, the control gate 20 coordinates examination of the content to be played by the customer and appropriately classifies this information in combination with the digital content management system 40. The digital content management system 40 provides the results of the review of the content to the control gate and the appropriate authorization for this play of the selected digital content. This content can also include real time streaming of audio and/or video content to the control gate.

The digital content management system 40 includes a bookkeeping function to record and process all the payment information and content identifying information including the digital content title (ID), number of times played, and/or the duration of each, and the total play time, depending on the content. This also provides copyright control and monitoring. For example, the control gate 20 can be set to operate and prohibit playing music that is not recognized by the digital content management system. In other cases, there may be certain owner or manual override provisions that allow the playing of music which is not recognized. In this way, unrecognized content can be prohibited or subject to authorized override. The digital content management system also provides effective accounting control and based thereon, provides reports for submission to the various copyright owners, label companies, software manufacturers, etc.

For the purpose of clarity and to better understand the operation of the system, the various components and functions have been separated. In implementing the system, these components may be combined. For example, the control gate may be part of the in-house system or integrated with the digital content management system or integrated with both of these functions. For example, the control gate could be a combination game/jukebox/input terminal available to customers. It could also be a modified jukebox having this terminal user file identification transfer/interaction capability.

There are also other arrangements for accessing audio/video files available for play in a public establishment and these arrangements can be used with the control gate function disclosed in the present application. Accessing authorized databases remotely located or onsite, provides a system that is less vulnerable to unauthorized play of material protected by copyright provisions while still satisfying or expanding the authorized play of material.

It is also possible to have the personal digital content devices include a separate function for interacting with public audio/video systems. These separate functions could be provided with the device or downloaded thereto. For example, known Music on Demand systems could be used with the present system to provide the appropriate authorization capability.

The digital content management system is authorized and tracks, and/or the play of the digital content. It is also possible for the control gate 20 to allow a user to communicate with an independent provider such as a Music on Demand provider. For example, a user can use the control gate 20 to access his account with the Music on Demand provider. This account can include a list of favourite music to simplify the selecting process for the user. The user can select the desired content and this content and/or identification information can be provided to the control gate. This content is preferably tracked as previously outlined by the digital content management system. It is also possible for authorization to be provided by the Music on Demand provider. For example, communication by the user using the control gate identifies this request as associated with use in a public establishment. The content could be streamed to the gate or transferred and temporarily stored, if authorized. Basically, the independent provider can be authorized from a copyright holder or group for authorizing this performance. Tracking can be provided by the control gate and/or the digital content management system regarding payments to the independent provider.

The present invention also includes the authorization of personal digital content devices for play of audio/video files on public audio/video systems by providing software to control this function.

The above system has been described primarily with respect to music and video content, however, it is also applicable to games and other forms of copyright material.

Although the digital content management system 40 can provide information feedback to the control gate 20 regarding the fee for playing of the copywritten material, this fee is preferably included in the cost per play charged by the control gate 20. With this arrangement, the digital content management system has authorized license provisions with the copyright owners or group providers.

The present invention and system provides an effective approach for the operator while allowing existing in-house audio and video systems to be used in a different manner and provide an additional income stream. Furthermore, it allows the operator to customize this in-house system for small group presentations. As can be appreciated, this could be suitable for business group lunches, etc.

As can be appreciated, the digital content management system will serve a large number of control gates at many commercial establishments.

There are many variations of this arrangement including the ability for the personal digital content devices merely to provide a list of the appropriate content to be played. IPod devices record the digital content in a manner easily used by the system. This list could have been derived from a pre-approved list available from the establishment or from the digital content system 40. For example, the material that is available for play could be provided on a website, etc., and the user could effectively pre-plan the particular material to be played.

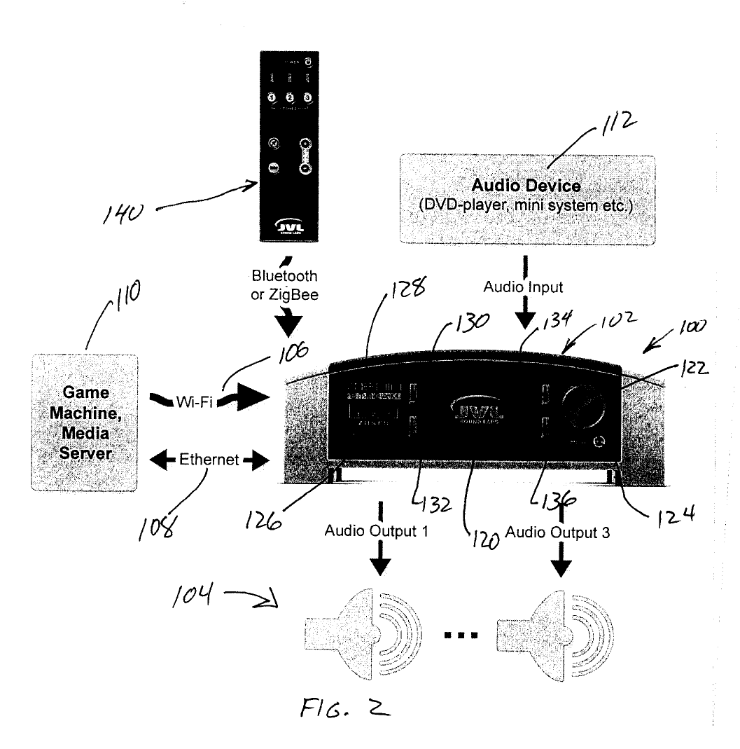

The above-described system uses the Media Center 10 to coordinate with the in-house systems. In contrast to this arrangement, the Media Center 100 shown in FIG. 2 includes its own amplifier system that is separately controlled, and provides outputs in various formats, either for use with an in-house system, or for output to a speaker system arrangement directly by the media center. With this arrangement, the Media Center 100 allows the end operator to appropriately adjust the system as he deems appropriate, and also allows for changes that might be necessary from time to time. In addition, the Media Center 100 can be provided with its own set of speakers and provide a proper sound system.

The Media Center 100 includes a media center device 102 which provides output to various speaker systems indicated as 104. The media center device 102 includes various options for connecting to a communication network, and these options are shown as a WIFI connection 106 or an Ethernet connection 108. The media center device 102 is in communication with a game machine and/or media server which are generally shown as 110. The media center device 102 can also communicate with other audio devices indicated as 112.

The media center device 102 is in communication with a content provider that will provide audio content to the media center device for play in the commercial establishment through one of the speaker arrangements indicated as 104. The Media Center 100 receives content to be played from an appropriate source. The game terminal or control gate acts as a combined selection terminal/payment terminal and to provide an instructing signal to the content provider.

The actual media center device 102 includes a display screen indicated as 120, a volume control indicated as 122, a mute control indicated as 124, a power on/power off actuator 126, channel indicators 128, and control actuators shown as 130, 132, 134 and 136.

One of the issues with respect to installing a complete system or adding a media center component to an existing system is the configuration of the media center component. The media center component preferably includes the ability to be automatically configured when it is first installed on location. The process of automatic configuration, or discovery, starts when the Media Center is turned on for the first time. Upon initializing it checks whether it has a configuration record on its internal memory storage. If such configuration record is missing, the Media Center enters Discovery mode and displays an appropriate message on its LED screen. At that point its network adapter is switching to ad-hoc mode, which allows it to establish communication with other ad-hoc devices on the same wireless or Ethernet network.

To proceed with the discovery process, the operator uses the Find Media Center feature in the control menu of the control gate 20. Upon activation of this feature, the control gate switches its network adapter to ad-hoc mode and starts broadcasting an encoded message. The Media Center receives the message and decodes it to identify the sender. It then sends a request to the control gate, identifying itself as device of compatible type. Upon receiving this request, the control gate sends to the Media Center a package containing a plurality of parameters. Those parameters include parameters of the network through which Media Center is supposed to reach the digital content management system and parameters of the location where the control gate is installed. After sending the parameters the control gate leaves ad-hoc mode, connects to digital content management system and waits for confirmation of Media Center registration.

Upon receiving the package with parameters, the Media Center switches its network adapter to managed mode, applies network settings and contacts the digital content management system using a secure connection over the Internet and submits an authentication request providing its serial number and location information obtained from the control gate.

The digital content management system verifies the serial number of the device, assigns this device to the location and responds to the Media Center with the code that signifies success. Media Stream exits Discovery mode and is ready to work.

The digital content management system also identifies all control gates installed on the location where Media Center was assigned to. It contacts all of the control gates and notifies them that Media Stream is now available on their location. Upon reception of this notification each control gate enables features related to Media Center, thus allowing location patrons to order music from all available sources.

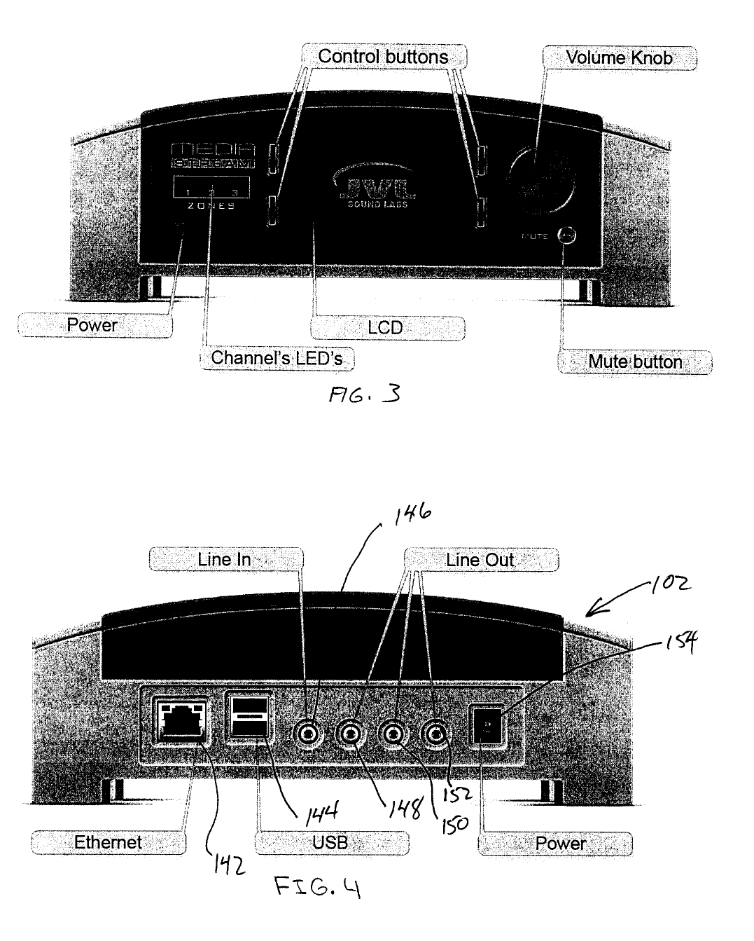

The media center device 102 also communicates with the remote control device indicated as 140. FIG. 3 is a view similar to FIG. 2 showing the media center device in additional detail. The media center device 102 includes a number of connections indicated in the rear view of FIG. 4. The device includes an Ethernet connection 142, a USB input arrangement 144, a line input indicated as 146, and three line-out channels indicated as 148, 150 and 152. The device also includes a power connection indicated as 154.

The media center device 102 functions with only one network connection, either the Ethernet or the WIFI network. The Ethernet is intended to be the main source for the network connection, and a WIFI antenna is hidden in the media center component.

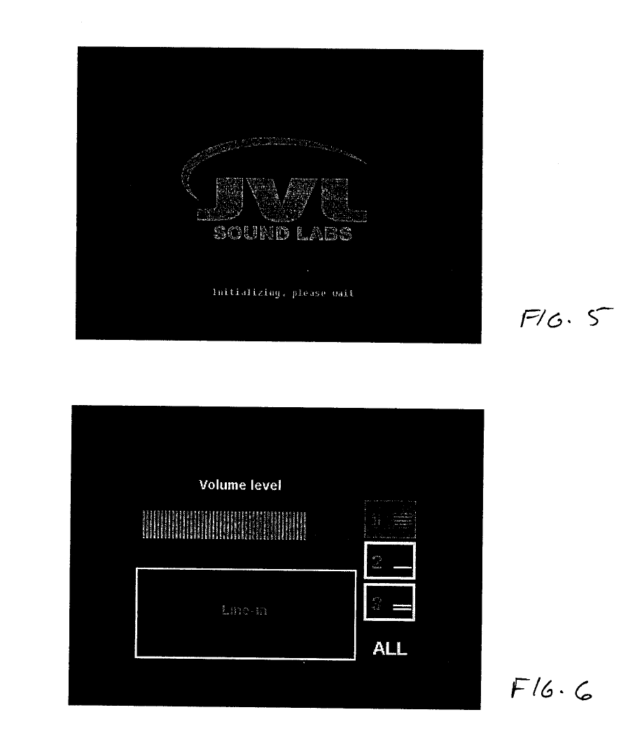

FIG. 5 shows an initial display screen that is produced when the media center device 102 is turned on by pressing of the actuator control 126. After an initial period, the device presents the volume levels for all channels that are shown on the main screen. This screen is shown in FIG. 6.

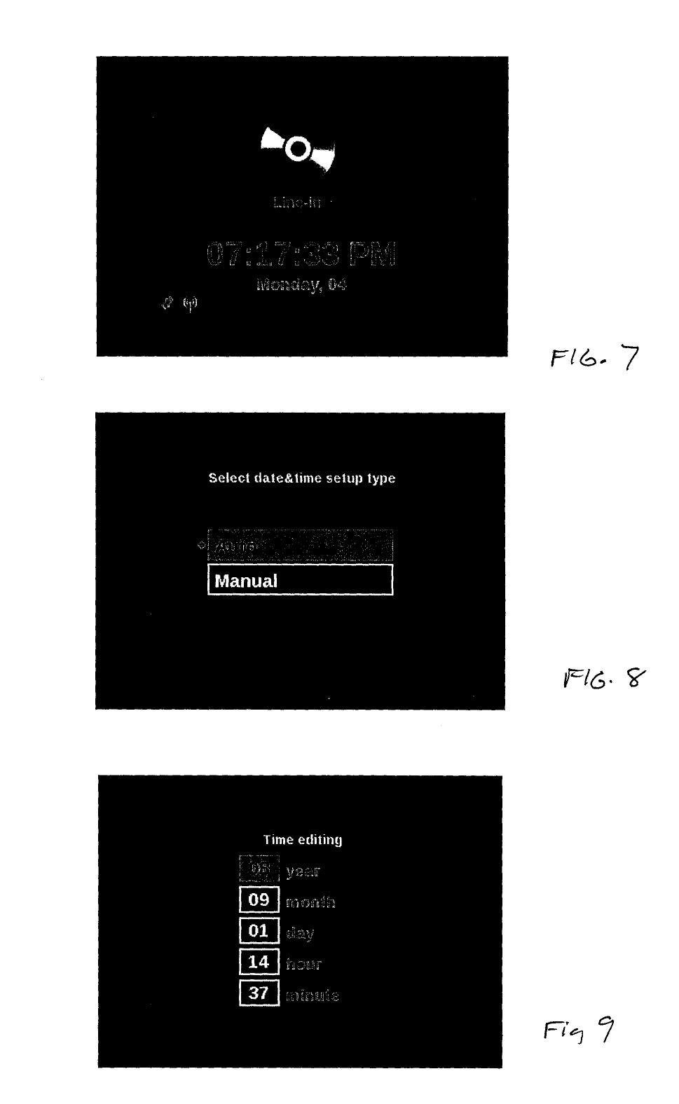

Various screens are provided depending upon what actuators are pressed on the device. If the media center component is left in a set configuration, the media center component will display a screen which displays the current time and date as shown in FIG. 7. This screen shows the particular day and time.

It is possible for the media center device 102 to either effect a communication with the remote data server to obtain date and time information, or can be placed in a manual mode where the operator enters this information. FIG. 8 shows the screen for allowing auto-collection of this information, whereas if the manual selection is made, the screen shot of FIG. 9 will be produced. Rotation of the volume control will allow the user to toggle through the different selections. Pressing of the volume control activates that particular selection, then allows adjustment thereof by rotation of the volume.

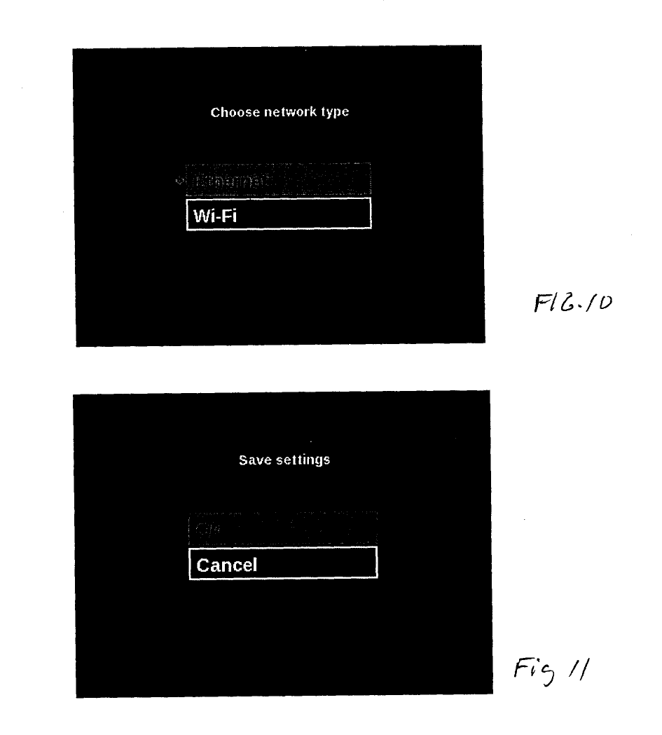

FIG. 10 is a screen shot showing how the different networks can be chosen. Once these networks have been changed, it is possible to save these connections by using the confirmation screen as shown in FIG. 11.

To access the various menus of the media center device 102, the volume button is pressed in and held for a certain period of time. This will then produce a screen which allows adjustment of the various functions of the device. The volume button is used to scroll through the various options by rotation of the volume control, and selection is confirmed by pressing of the volume button. It is possible to return to an earlier screen by pressing of the “MUTE” actuator.

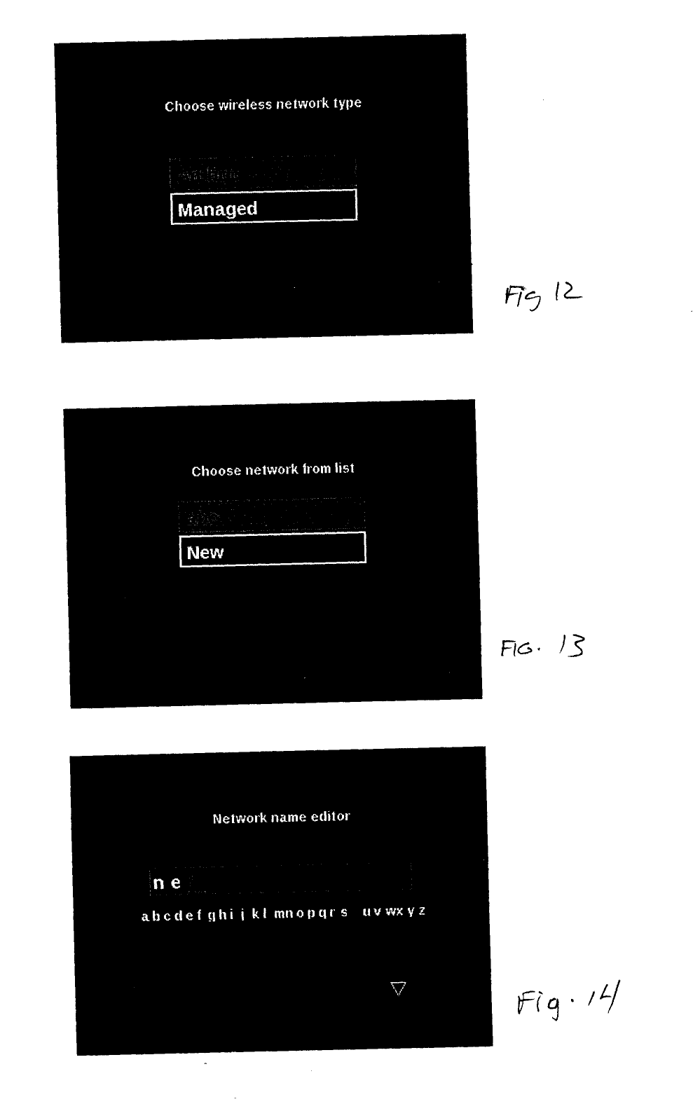

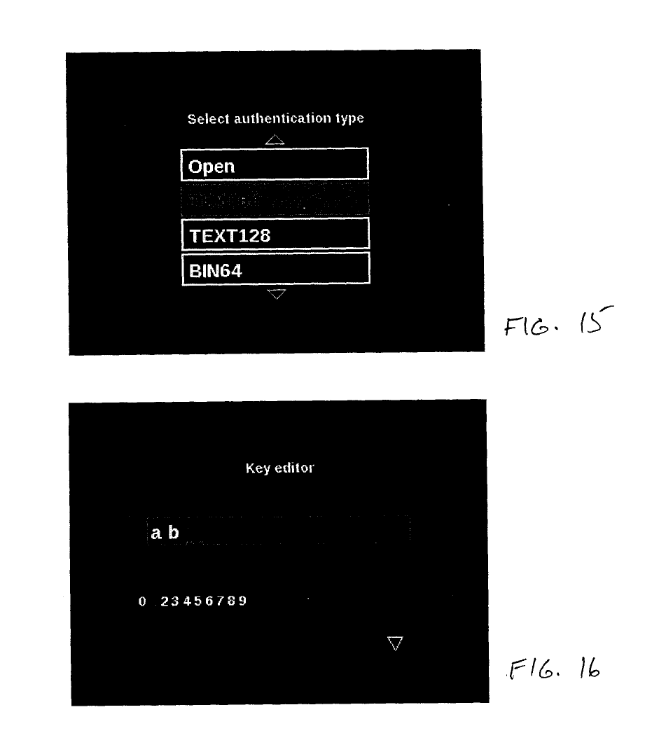

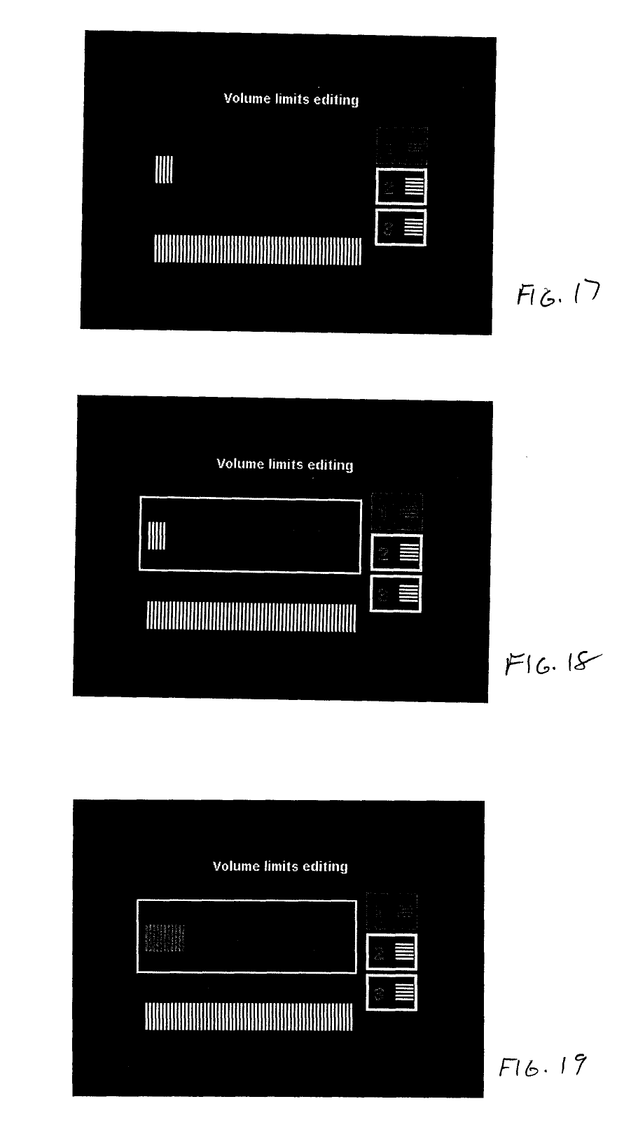

FIG. 10 also indicates that a WIFI connection can be used. If this is required, a subsequent screen as shown in FIG. 12 is provided where the appropriate option for managing of the WIFI network is provided. Once the management has been decided, a subsequent list will be provided of the detected WIFI networks as indicated in FIG. 13. This also allows entry of new names for the networks as indicated in FIGS. 13 and 14. Further editing of these is shown in FIG. 15, and an authentication key is shown being entered in FIG. 16.

FIGS. 17, 18 and 19 show volume editing for various channels. In FIG. 17, channel 1 is being adjusted. In FIG. 17, this screen is produced after the volume limit has been selected from a general menu. The user then uses the volume knob to select the appropriate channel and then presses the volume control to adjust the limits for that particular channel. As seen in FIG. 18, channel 1 was selected and the lower volume limit can now be adjusted by control of the volume control. Once the desired value has been inputted, such as shown in FIG. 19, this setting can be saved by pressing the volume control. As can be appreciated, the other channels may be adjusted in this manner, and it is also possible to adjust all of the channels to have the same output by using the “ALL” button.

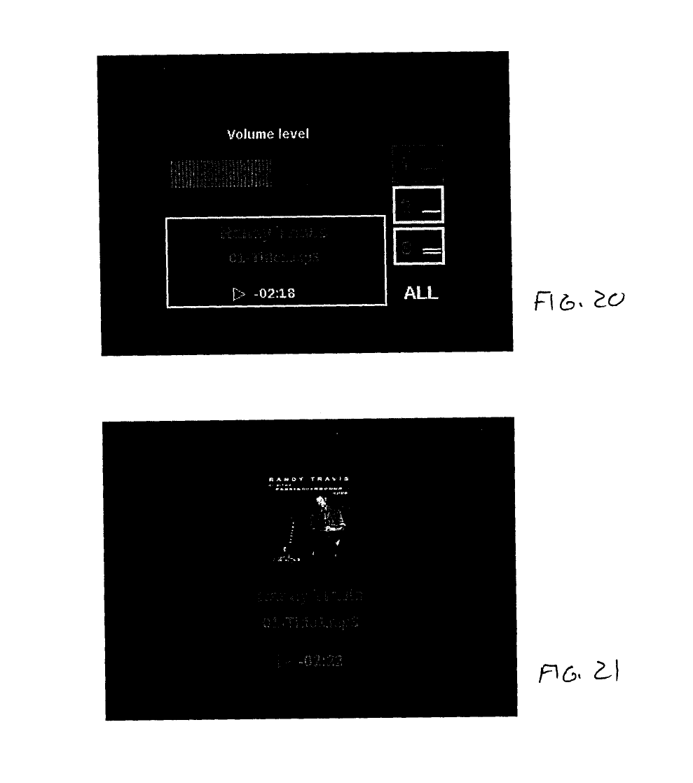

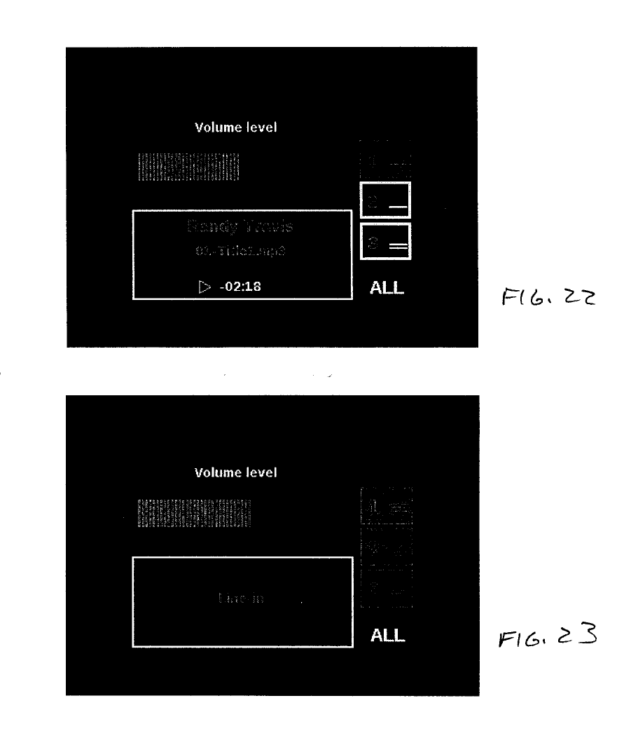

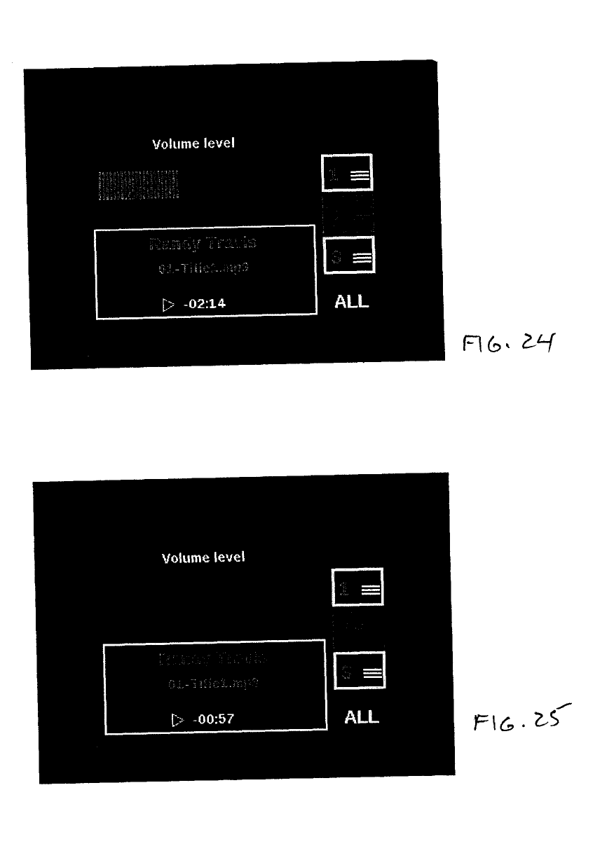

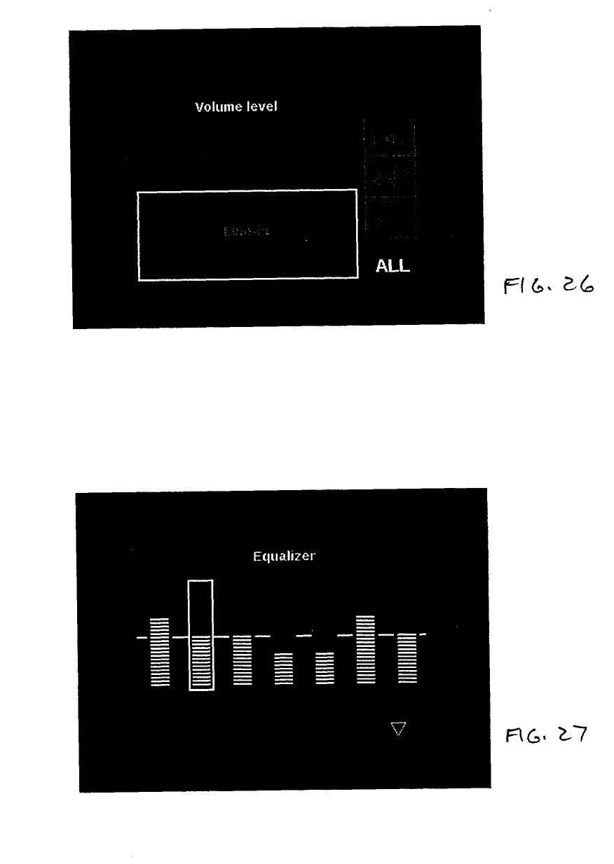

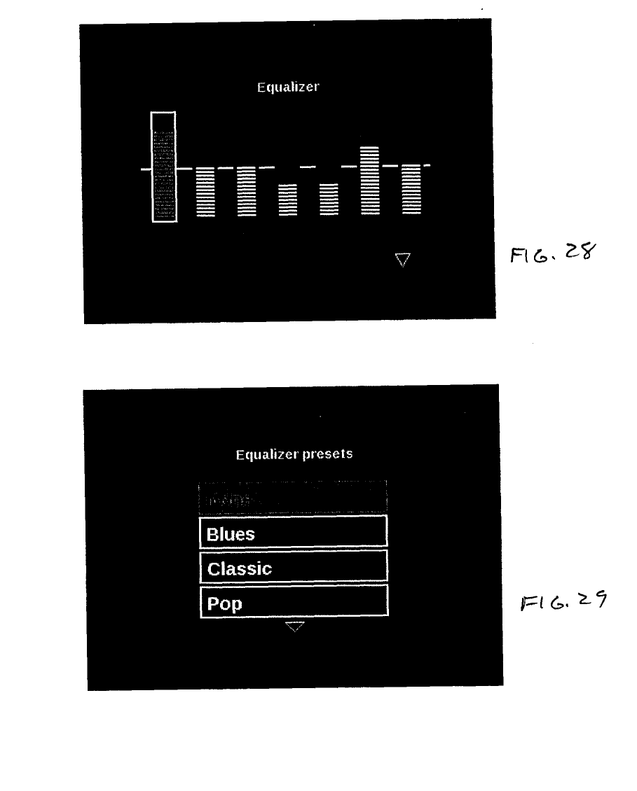

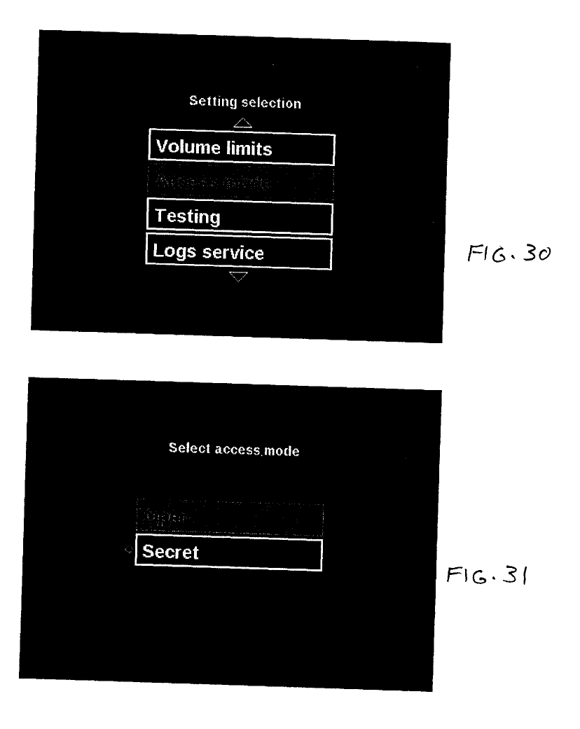

If the media center device 102 is outputting a particular audio track to one of the speaker systems, a display can be observed as indicated in FIG. 20. In this case, channel 1 is shown with the particular volume level being indicated, and the particular recording “RANDY TRAVIS” being provided. In some cases, the album cover for this particular record may also be provided as indicated in FIG. 21. The summary-type screen also includes details of the time remaining for that track.

As shown in FIGS. 22 and 23, the selected channels for an adjustment are shown as a filled in box with channel 1 being indicated in FIG. 22, and all three channels being indicated in FIG. 23. The adjustment of FIG. 2 to actuate the “ALL” button produces the common screen of FIG. 23. Subsequent adjustment of the volume level applies to all of the channels if adjusted in FIG. 23.

FIG. 24 shows adjustment of the volume level for the selected channel 2.

In FIG. 25, the screen shot indicates when the “MUTE” button has been pressed. For example, the screen is shown in FIG. 24 for use in association with channel 2, and in the screen shot of FIG. 25 channel 2 has been muted by actuation of the “MUTE” button. It is also possible to mute all of the channels by pressing the “ALL” button in FIGS. 24 and 25 and this results in the screen generally indicated as 26.

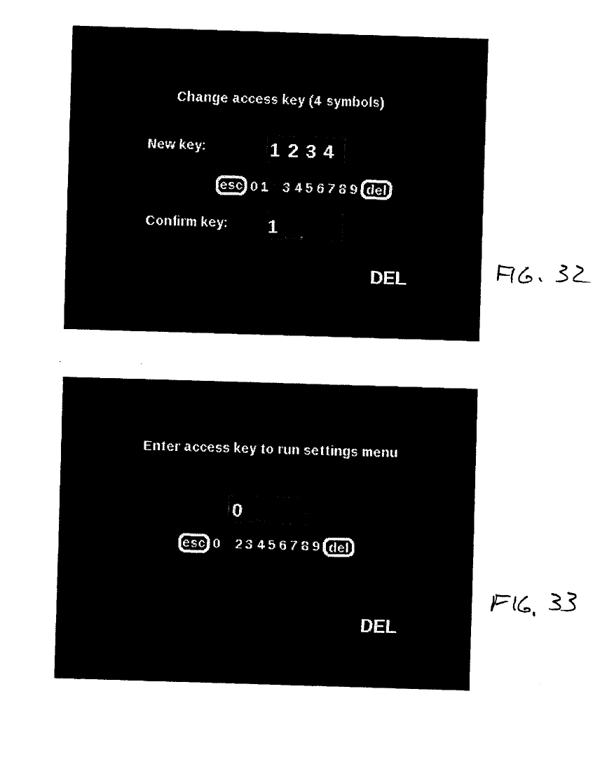

Adjustments of the actual amplifier is similar to most stereo systems and includes the equalizer adjustment as indicated in FIG. 27. This equalizer adjustment is accessed through a general menu. The various frequency ranges can be selected by moving of the volume control, and adjustment can be effected by selecting it and then further rotation of it. If it is desired to then save that particular adjustment, the volume control is pressed. The volume control is then able to rotate to a different frequency range for adjustment. These aspects are shown in FIG. 28.

It is also possible to adjust the equalizer in a standard-type arrangement as shown with the adjustment in FIG. 29.

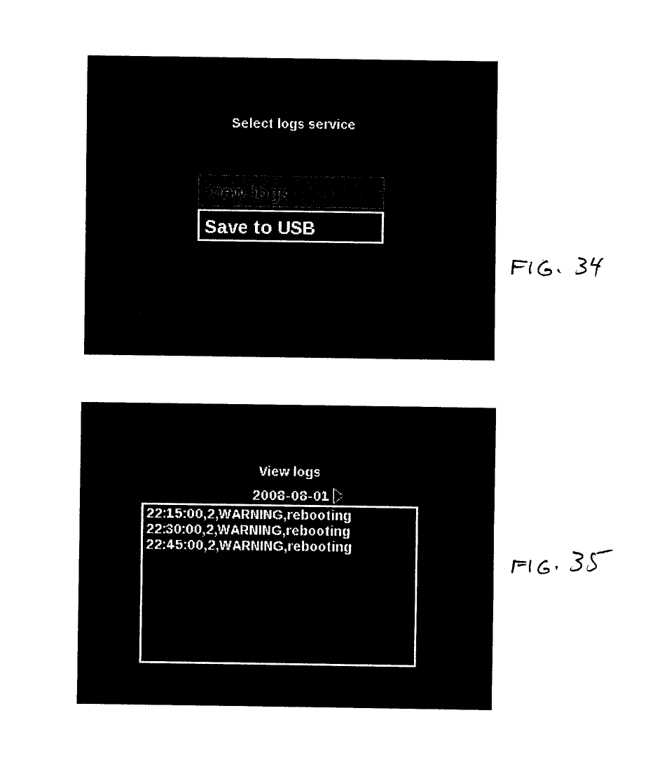

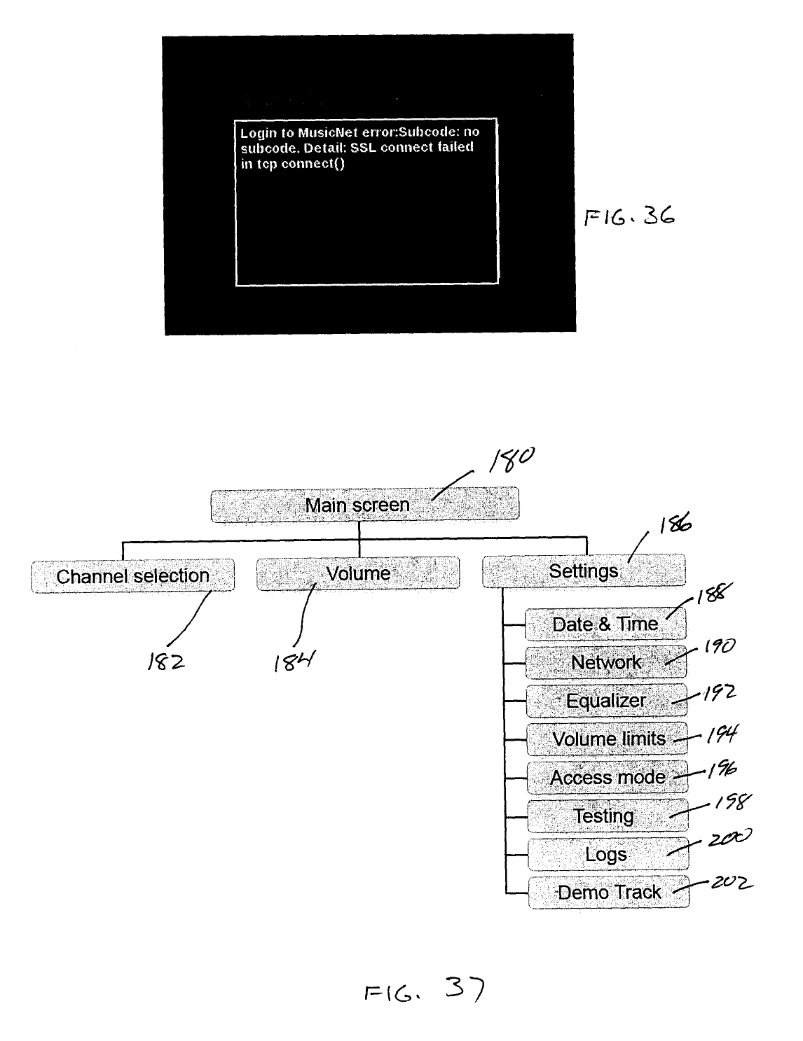

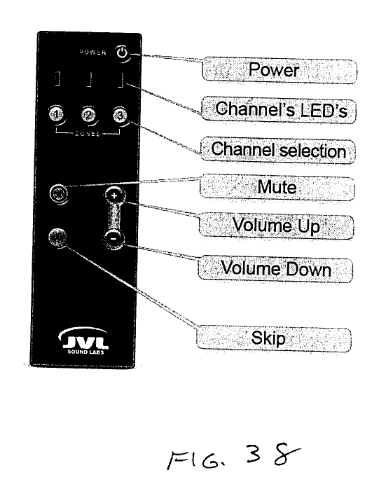

FIG. 30 shows the general screen adjustment or menu and the arrows top and bottom of the adjustments indicate that additional controls are provided. This allows the operator to access the particular mode. It may be desired to effectively provide operator control on the media center component such that unauthorized personnel cannot adjust the same. This is indicated in FIG. 31, where a secret code is being entered and these are indicated in FIGS. 32 through 33. The screen shots of FIGS. 34 and 35 as well as 36 show additional screens that can be accessed indicating performance of the media center component.

The USB ports provided on the back of the media center component can be used by the operator to save logs of the performance of the media center component to the media stick. This will allow him to review the performance at a different location.

FIG. 37 shows the functional relationship associated with the screen shots produced by the media center device 102. The device produces an initial main screen indicated as 180 and adjustment of the main screen provides access to the channel selection 182, the volume control selection 184, and setting selections 186. The setting selections 186 include date and time 188, network adjustment 190, equalizer adjustment 192, volume limits 194, access mode 196, testing 198, logs indicated as 200, and a demo track indicated as 202. The demo track allows the operator to initially set up the media center device 102 and ensure that it is operating satisfactorily. Basically, the demo track is outputted in the manner programmed according to the device, and allows the user to thereby test it without actually receiving a signal from the remote server.

The media center device has a full scale computer processor and uses Linux for flexibility and stability. It plays any media content from external encryption protected digital source as well as external radio analog line input and content from the USB. Other advantages include

1. Remote skins (similar to winamp) update, without user intervention. Update can be carried out from a remote server, or Media server. Example: Christmas theme with Christmas tree and themed UI elements
2. Remote F/W update to support any media file formats with, or without encryption and various algorithms. Also possible without user intervention.
3. Combination in one device of several technologies to communicate with various Servers. Ethernet, WiFi, external USB dongles such as USB/Ethernet, USB/WiFi, USB/WiMAX and automatic navigation among streams from different connections.
4. User can utilize 3 sound sources: Line-In, Media Server and USB memory storage.
5. Contains 2 high speed USB Host connectors for USB memory support and wireless speakers and so forth. Linux OS facilitates automatic upload and integration of drivers for the future communication devices.
6. SPI FLASH used for boot and System storage for BF537 MCU to optimize its I/O utilization. Frees peripheral ports for glue-less connection to various interfaces and expanded User Interface using color LCD, 6 pushbuttons and jog dial with push function.
7. Optimize power distribution architecture to eliminate switching power sources on board for noise minimization and resulting in excellent sound quality.
8. LEDs indicators allows for 3 colors using only 2 terminals, further saving MCU peripheral I/Os.
9. Channel Load indication scheme: Green color means a channel is playing free music from broadcast source; Yellow—muted channel; Red—paid content playing. It allows the Operator to see comprehensive device status before turning it off or changing the volume on a given channel.
10. Color graphical representation of the Album Art of a CD jacket using color LCD display.
11. Device Real Time is synchronized with the media server, or internal time keeping protected by the backup battery. MBX can also be used as a stylish Clock.
12. Minimalist User Interface controlled using only the Jog Dial and 2 buttons plus the Power. The functions of the 2 soft buttons depends on the state of the menu.
13. In the absence of the commercial music a Broadcast audio content plays automatically. Possible to set to play the content from a USB memory storage.
14. To facilitate convenient setup a test music clip is available internally to allow volume adjustment on every channel and verify proper device functionality in the absence of any communications.
15. No direct line of vision is required for control of the MBX through several obstacles using long range FCC compliant RF remote. The non-interfering obstacles could be walls, or a ceiling, or a floor barrier. LED light feedback on the Remote control confirms correct command execution.
16. MBX keeps log records internally and transmits to the Server during normal operation. They can be also accessed on MBX LCD screen through the User Interface menu, or output to the USB memory storage.
17. Economical implementation of AC97 5.1 codec for PC computers as Hi-Fi D/A converter for 3 stereo channels.
18. Introduction of special functionality of the button “ALL” to simultaneously control volume in 2 or 3 zones at the same time using either a Remote Control, or the MBX Front Panel.
18. Usage of an associated Video game Machine to play music in addition to playing games.
19. Provide Zone 1 output with Internal Stereo Power Amplifier for simplified on-location setup: only External Speakers in addition to the MBX are required for minimal deployment.

Although various preferred embodiments of the present invention have been described herein in detail, it will be appreciated by those skilled in the art, that variations may be made thereto without departing from the spirit of the invention or the scope of the appended claims.

1. A media center component for use in a system for play of digital records comprising:
a web based communication function;
at least art audio signal input for receiving digital signals of audio records to be played on said system;
a plurality of outputs for outputting to audio systems requiring different signal outputs; and
wherein said media center component includes controls adjustable by a user to modify the outputted audio signal.

2. A media center component as claimed in claim 1 wherein said controls include stereo amplifier controls common to stereo systems.

3. A media center component as claimed in claim 1 wherein said media center component includes an output for direct connection with speakers.

4. A media center component as claimed in claim 3 wherein said media center component includes a computer processor and memory and is adapted to receive a streamed audio signal that is processed and outputted to at least one of said outputs.

5. A media center component as claimed in claim 1 including an initial installment procedure, said installment procedure when activated and said component connected to a local area network transmitting a signal to possible related equipment which if present provide location information.

6. A media center component as claimed in claim 5 wherein said transmitted signal of said installment procedure also requests communication information used by said media center component.
